(19) United States
(12) Patent Application Publication
(10) Pub. No.: US 2010/0283582 A1
(43) Pub. Date: Nov. 11, 2010

(54) Wireless Communication Apparatus

(75) Inventors: Hideto FUJITA, Osaka (JP); Naoki OGASAWARA, Osaka (JP)

Correspondence Address: NOVAK DRUCE DELUCA + QUIGG LLP, 300 NEW JERSEY AVENUE NW, FIFTH FLOOR, WASHINGTON, DC, 20001, US

(73) Assignee: SANYO ELECTRIC CO., LTD., Osaka (JP)

(21) Appl. No.: 12/775,576

(22) Filed: May 7, 2010

(30) Foreign Application Priority Data
May 8, 2009 (JP) 2009-114042
Apr. 26, 2010 (JP) 2010-100599

(51) Int. Cl. G08B 5/22; H04N 5/225

(52) U.S. Cl. 340/7.37; 348/207.1; 348/E05.024

(57) ABSTRACT

A wireless communication apparatus conducts wireless communication with an external apparatus. The wireless communication apparatus includes an image capture unit which captures an image of a subject, a memory which stores image data based on the captured image, an establishment unit which establishes wireless communication between the external apparatus and the body of the wireless communication apparatus, a communication unit which transmits the image data to the external apparatus by the wireless communication as established, a battery which supplies power to the image capture unit and the communication unit, a determination unit which detects remaining battery power of the battery to determine whether or not the detected remaining battery power falls below a predetermined value, and a control unit which disconnects the wireless communication established by the establishment unit, based on a determination that the remaining battery power falls below the predetermined value, to interrupt transmission of the image data conducted by the communication unit.

This nonprovisional application is based on Japanese Patent Application No. 2009-114042 filed on May 8, 2009 and No. 2010-100599 filed on Apr. 26, 2010 with the Japan Patent Office, the entire contents of which are hereby incorporated by reference.

### BACKGROUND OF THE INVENTION

1. Field of the Invention

The present invention relates to a wireless communication apparatus having a wireless communication capability which conducts wireless communication with another wireless communication apparatus. The present invention particularly relates to a wireless communication apparatus which effects communication control depending on a voltage of a battery inserted into the body of the wireless communication apparatus.

2. Description of the Background Art

Recently, a digital camera is known which is loaded with an external memory card having a wireless communication capability to implement a function (by hardware and software) corresponding to a client in a wireless LAN (Local Area Network).

With this configuration, the digital camera can be connected via the external memory card to a network through a base station (access point) of the wireless LAN, without having any wireless LAN client function within the digital camera body.

Another known digital camera utilizes an external memory card as recording medium for the digital camera to achieve communication over a wireless LAN.

### SUMMARY OF THE INVENTION

When conducting wireless LAN communication, a digital camera loaded with the above-described external memory card (hereinafter also referred to as “wireless LAN built-in memory card”) utilizes power used for an image capture operation, for example. There are at least two power sources for the wireless LAN built-in memory card: one is a commercial power source used via an AC adapter connected to the digital camera; and the other is a battery inserted into the digital camera.

There are at least two styles of conducting wireless LAN communication via the wireless LAN built-in memory card in the above-described digital camera. One of the styles is to conduct wireless LAN communication during image capture, image data reproduction, or the like with the digital camera being held in user's hand. The other style is to conduct wireless LAN communication without the digital camera being held in user's hand and while image capture, image data reproduction, or the like is not conducted.

In the latter style of wireless LAN communication, the following problem arises when power of a battery inserted into the digital camera is utilized for conducting wireless LAN communication via the wireless LAN built-in memory card. More specifically, even when a situation occurs, for example, in which power consumption resulting from the wireless LAN communication causes the battery to significantly drop in voltage, the user, keeping his/her hands off the digital camera, may be unaware of the battery voltage drop.

Then, when the user is going to use the digital camera while holding the camera in hand just after the above-described situation occurred, the digital camera may be unable to execute a user's desired operation since the battery voltage has significantly dropped.

In accordance with an aspect of the present invention, a wireless communication apparatus conducts wireless communication with an external apparatus. The wireless communication apparatus includes an image capture unit which captures an image of a subject, a memory which stores image data based on the captured image, an establishment unit which establishes wireless communication between the external apparatus and a body of the wireless communication apparatus, a communication unit which transmits the image data to the external apparatus by the wireless communication as established, a battery which supplies power to the image capture unit and the communication unit, a determination unit which detects remaining battery power of the battery to determine whether or not the detected remaining battery power falls below a predetermined value, and a control unit which disconnects the wireless communication established by the establishment unit, based on a determination that the remaining battery power falls below the predetermined value, to interrupt transmission of the image data conducted by the communication unit.

In accordance with another aspect of the present invention, a wireless communication apparatus conducts wireless communication with an external apparatus. The wireless communication apparatus includes a memory which stores image data, an establishment unit which establishes wireless communication between the external apparatus and a body of the wireless communication apparatus, a communication unit which transmits the image data to the external apparatus by the wireless communication as established, a display unit which displays the image data, a battery which supplies power to the communication unit and the display unit, a determination unit which detects remaining battery power of the battery to determine whether or not the detected remaining battery power falls below a predetermined value, and a control unit which disconnects the wireless communication established by the establishment unit, based on a determination that the remaining battery power falls below the predetermined value, to interrupt transmission of the image data conducted by the communication unit.

In accordance with still another aspect of the present invention, a wireless communication apparatus conducts wireless communication with an external apparatus. The wireless communication apparatus includes a sound pickup device which converts a sound wave into an electric signal, a memory which stores audio data based on the electric signal, an establishment unit which establishes wireless communication between the external apparatus and a body of the wireless communication apparatus, a communication unit which transmits the audio data to the external apparatus by the wireless communication as established, a battery which supplies power to the sound pickup device and the communication unit, a determination unit which detects remaining battery power of the battery to determine whether or not the detected remaining battery power falls below a predetermined value, and a control unit which disconnects the wireless communication established by the establishment unit, based on a determination that the remaining battery power falls below the predetermined value, to interrupt transmission of the audio data conducted by the communication unit.

Preferably, the wireless communication apparatus further includes a receiving unit which receives an input, and a changing unit which changes the predetermined value based on the input as received.

Preferably, the determination unit includes a level detecting unit which detects an output voltage level of the battery, and a level determining unit which determines whether or not the output voltage level falls below a predetermined level. The determination unit determines that the remaining battery power of the battery falls below the predetermined value when the level determining unit determines that the output voltage level falls below the predetermined level.

Preferably, the wireless communication apparatus further includes a receiving unit which receives an input, and a changing unit which changes the predetermined level based on the input as received.

Preferably, the control unit causes the establishment unit to establish the wireless communication when the power is supplied from an external power source instead of the battery while the transmission is interrupted by the control unit.

Preferably, the receiving unit is a user interface which receives a user's operation.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 diagrammatically shows a wireless communication apparatus.

FIG. 2 is a block diagram of a digital camera loaded with a memory card.

FIG. 3 is a transition diagram showing some of menu screens displayed on an LCD of the digital camera.

FIG. 4 is a flow chart showing a part of an operation executed by a main CPU in the digital camera.

FIG. 5 is a flow chart showing another part of the operation executed by the main CPU.

### DESCRIPTION OF THE PREFERRED EMBODIMENTS

With reference to the drawings, detailed description will be given of preferred embodiments of the present invention. In the drawings, identical or corresponding components are shown with an identical reference sign and description thereof will not be given repeatedly.

Hereinafter, a digital camera will be described as an example of a wireless communication apparatus according to an embodiment of the present invention.

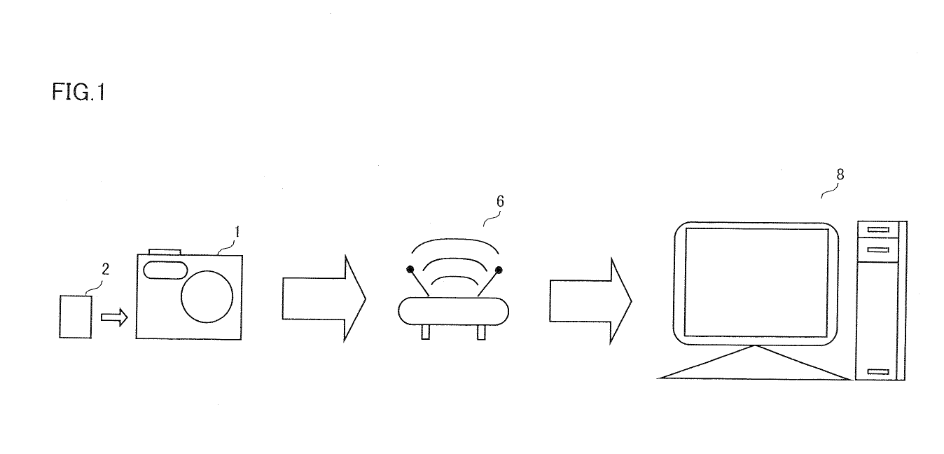

FIG. 1 shows the wireless communication apparatus. With reference to FIG. 1, a digital camera 1 loaded with a wireless LAN built-in memory card 2 (hereinafter referred to as “memory card 2”) conducts wireless LAN communication with a personal computer 8 (hereinafter referred to as “PC 8”).

First, a user inserts memory card 2 into PC 8 with predetermined software installed. PC 8 then subjects memory card 2 to a predetermined setup. When inserted into digital camera 1, memory card 2 having been set up receives a Service Set Identifier (SSID) which is an access point of a wireless LAN broadband router 6 (hereinafter referred to as “router 6”) having the function of a base station in a wireless LAN. When the received SSID coincides with an SSID having been previously set up by PC 8 and when encryption keys coincide with each other, a connection is established between memory card 2 which is a client and router 6 which is an access point. It is to be noted that wireless LAN communication is also established between router 6 and PC 8 via a wireless LAN adapter (not shown) connected to PC 8.

When the user operates digital camera 1 to enable wireless LAN data communication, image data obtained by an image capture operation performed by digital camera 1 is transferred from digital camera 1 to PC 8 via memory card 2 and router 6. It is to be noted that the image capture operation represents capturing an optical image of a subject, and generating an image signal based on the captured optical image. The image capture operation will be described later in detail.

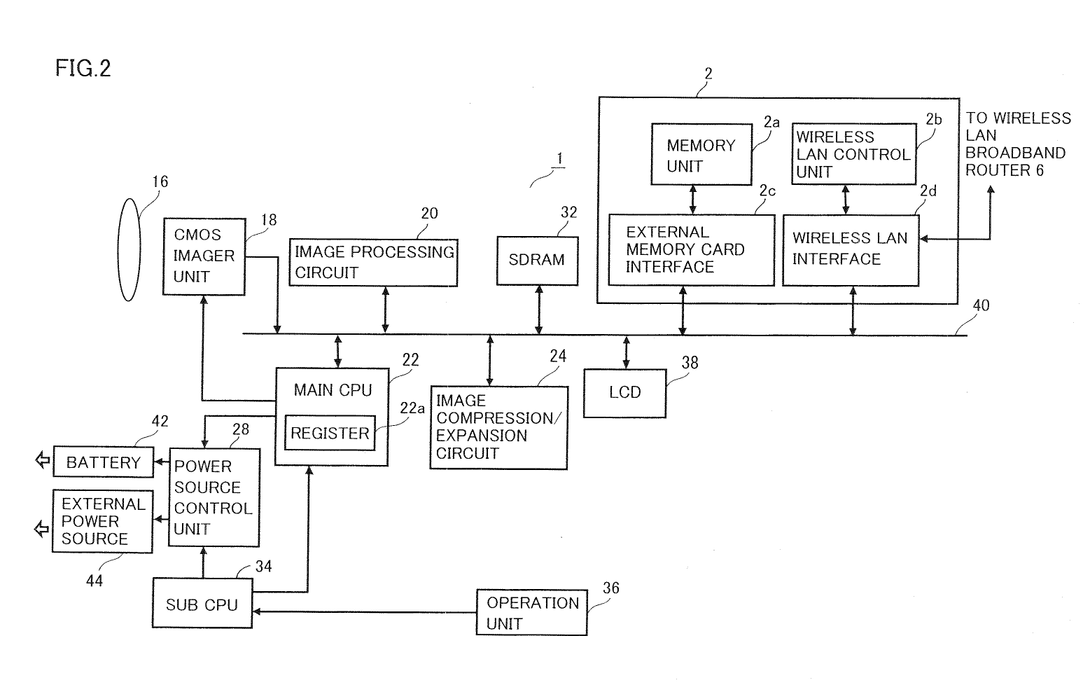

FIG. 2 is a block diagram of digital camera 1 loaded with memory card 2. A detailed description will now be given with reference to FIG. 2.

Digital camera 1 includes an optical lens 16 and an aperture (not shown). In accordance with a command issued by a main CPU (Central Processing Unit) 22, an optical image of a subject is captured into a CMOS (Complementary Metal Oxide Semiconductor) imager unit 18 through optical lens 16 and the above-mentioned aperture which are controlled by a motor drive unit (not shown).

CMOS imager unit 18 outputs a digital captured-image signal for one frame in accordance with a pulse for capturing the frame supplied by a timing generator (not shown) connected to main CPU 22. CMOS imager unit 18 amplifies charges stored per pixel, and reads out the amplified charges, as a signal, from each pixel via an interconnection wire. Further, CMOS imager unit 18 subjects the signal as read out to correlated dual sampling, gain adjustment, clamping, and A/D (Analog/Digital) conversion.

The signal having undergone these kinds of processing (digital captured-image signal) includes either color signal of R, G or B per pixel. Main CPU 22 temporarily stores the digital captured-image signal on an SDRAM (Synchronous Dynamic Random Access Memory) 32 via a bus 40.

Main CPU 22 inputs the digital captured-image signal temporarily stored on SDRAM 32, to a signal processing circuit 20. Signal processing circuit 20 subjects the received digital captured-image signal to color separation. Further, signal processing circuit 20 subjects the signal having undergone the color separation, to YUV conversion. Signal processing circuit 20 obtains Y, U, and V signals by this conversion. Main CPU 22 stores the digital image signals obtained by the conversion at signal processing circuit 20, on SDRAM 32 again via bus 40. It is to be noted that, according to the present embodiment, the “image capture operation” is defined as a sequential process including converting a digital captured-image signal output from the aforementioned CMOS imager unit 18 into a digital image signal at signal processing circuit 20, and storing the digital image signal on SDRAM 32.

Main CPU 22 outputs the digital image signal stored on SDRAM 32, to an LCD (Liquid Crystal Display) 38. LCD 38 includes an LCD driver (not shown). The LCD driver converts Y, U, and V signals into R, G, and B signals. The LCD driver causes LCD 38 to display an image signal based on the digital image signal.

An image compression/expansion circuit 24 subjects the digital image signal stored on SDRAM 32, to compression. Main CPU 22 stores the digital image signal, as a compressed image signal, on SDRAM 32 again via bus 40. Main CPU 22 stores the compressed image signal stored on SDRAM 32, in a memory unit 2a through an external memory card interface 2c within memory card 2.

An operation unit 36 includes a cursor key, a menu key, a set key, and a main switch that permits/stops power supply from a battery 42 serving as a power source for the body of digital camera 1 or an external power source 44. It is to be noted that power of battery 42 is not supplied to the body of digital camera 1 when external power source 44 is connected to digital camera 1.

Operation unit 36 is connected to a sub CPU 34. Sub CPU 34 detects that any of the above-mentioned keys of operation unit 36 has been operated. Sub CPU 34 sends an identification signal, as a result of detection, to main CPU 22 and/or a power source control unit 28. Power source control unit 28 executes power source control in accordance with a command issued by sub CPU 34 or main CPU 22. More specifically, power source control unit 28 permits/stops power supply from battery 42 or external power source 44.

When the cursor key, the menu key, and the set key are operated in a predetermined manner as will be described later, main CPU 22 controls a wireless LAN control unit 2b to enable/disable data communication over a wireless LAN. With the data communication enabled, the compressed image data stored in memory unit 2a is transmitted to router 6 through external memory card interface 2c and a wireless LAN interface 2d. Router 6 transfers the compressed image data to PC 8.

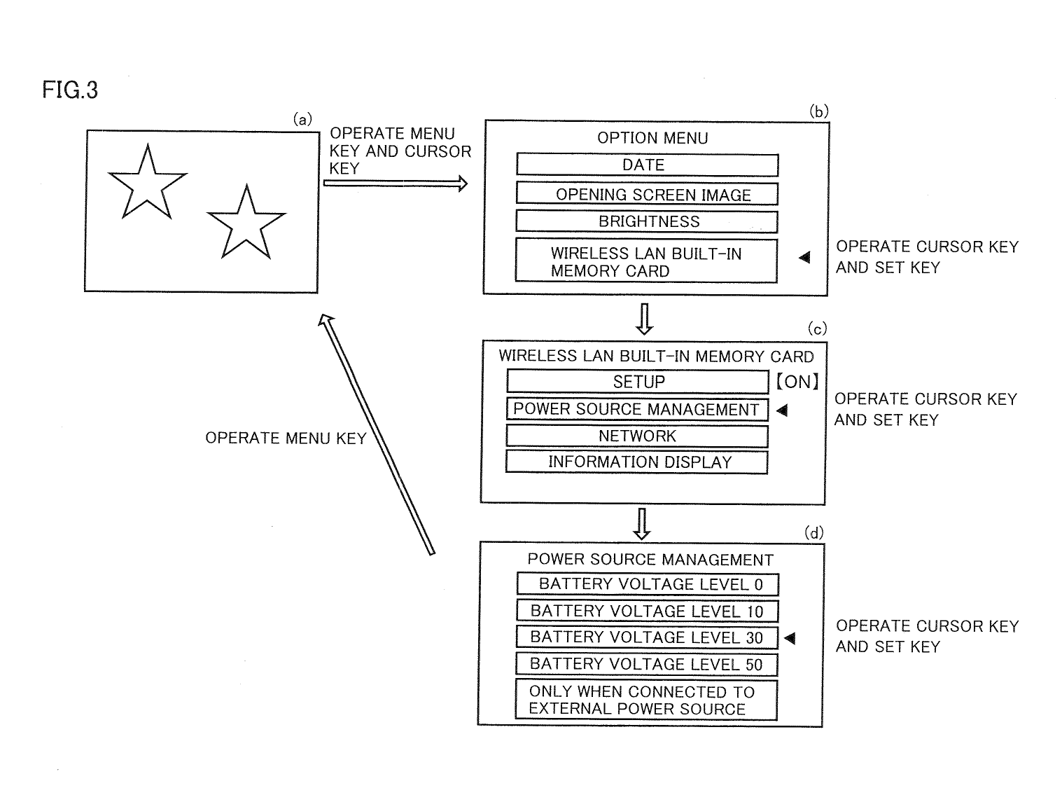

It has been described above that digital camera 1, when loaded with memory card 2, is capable of conducting wireless LAN communication. Digital camera 1 according to the present embodiment further allows a user to set a communication method depending on his/her desired usage in wireless LAN communication. The procedure in that case will now be described with reference to FIG. 3.

FIG. 3 is a transition diagram showing some of menu screens displayed on LCD 38 of digital camera 1. As shown at (a) in FIG. 3, when the menu key and the cursor key of operation unit 36 are operated while LCD 38 displays an image based on a digital image signal, digital camera 1 displays an option menu screen on LCD 38 as shown at (b) in FIG. 3. Digital camera 1 is previously provided with, as option menus, the items of “Date”, “Opening Screen Image”, “Brightness”, and “Wireless LAN Built-in Memory Card 2”.

By operating the cursor key to place the cursor on the item of “Wireless LAN Built-in Memory Card” and then operating the set key, digital camera 1 displays, on LCD 38, a setting screen shown at (c) in FIG. 3. More specifically, digital camera 1 displays a wireless LAN built-in memory card setting screen on LCD 38 on which detailed settings on memory card 2 are made. Digital camera 1 is previously provided with the items of “Setup”, “Power Source Management”, “Network”, and “Information Display” for setting up the wireless LAN built-in memory card.

By operating the cursor key and the set key to select the item of “Setup”, the user can set whether to enable (establish) or disable (interrupt) wireless LAN communication. When selecting the item of “Power Source Management”, the user can make the settings for controlling wireless LAN communication depending on the voltage level of the power source, as will be described later. When selecting the item of “Network”, the user can set his/her desired access point if there are several access points. It is to be noted that the present embodiment will be described assuming that there is a single access point for ease of description. When the user selects the item of “Information Display”, digital camera 1 displays the current status of wireless LAN communication on LCD 38.

When the user selects the item of “Power Source Management” (cf. FIG. 3 at (c)), digital camera 1 displays, on LCD 38, the items of “Battery Voltage Level 0”, “Battery Voltage Level 10”, “Battery Voltage Level 30”, “Battery Voltage Level 50”, and “Only When Connected to External Power Source”, as shown at (d) in FIG. 3. Digital camera 1 receives a user's item selection with the respective items displayed on LCD 38. The digital camera performs power source management in accordance with the selected item.

Even if wireless LAN communication has been enabled by setting, digital camera 1 automatically disables wireless LAN communication when the current voltage (remaining battery power) of battery 42 falls below a level set in the item of power source management. Digital camera 1 thereby ensures the battery voltage level set by the user. This can avoid an inconvenience such as one that power shortages caused by consumption of power of battery 42 by wireless LAN communication lead to unusableness of the digital camera although the user wishes to use digital camera 1, except when the item of “Battery Voltage Level 0” has been selected. Accordingly, digital camera 1 achieves power source management depending on user's desired usage.

In the present embodiment, a state in which battery 42 is fully charged is called the battery voltage level 100. A state in which battery 42 is charged with half of the charges in the fully charged state is called the battery voltage level 50. A state in which charges are exhausted is called the battery voltage level 0.

Assuming that “Battery Voltage Level 0” has been selected in the item of “Power Source Management”, main CPU 22 issues a command for disabling wireless LAN communication to wireless LAN control unit 2b, upon recognition that the current battery voltage level is at 0 (i.e., the remaining battery power is 0%). Wireless LAN control unit 2b disables wireless LAN communication based on this command. The battery voltage level selected in the item of “Power Source Management” is stored in a register 22a. Herein, main CPU 22 detects the battery voltage level based on the voltage value of battery 42.

Assuming that “Battery Voltage Level 10” has been selected, main CPU 22 issues the command for disabling wireless LAN communication to wireless LAN control unit 2b, upon recognition that the current battery voltage level is at 10 or below (i.e., the remaining battery power is 10% or less). Similarly, assuming that “Battery Voltage Level 30” has been selected, main CPU 22 issues the command for disabling wireless LAN communication to wireless LAN control unit 2b, upon recognition that the current battery voltage level is at 30 or below (i.e., the remaining battery power is 30% or less). Assuming that “Battery Voltage Level 50” has been selected, main CPU 22 issues the command for disabling wireless LAN communication to wireless LAN control unit 2b, upon recognition that the current battery voltage level is at 50 or below (i.e., the remaining battery power is 50% or less).

Assume that wireless LAN control unit 2b disables wireless LAN communication based on that main CPU 22 has recognized that the current battery voltage level is at 50 or below. In this state, assume that the user replaces battery 42 with another battery. In this case, main CPU 22 issues a command for enabling wireless LAN communication to wireless LAN control unit 2b, upon recognition that the current battery voltage level is higher than 50. Also, in the above-mentioned state that wireless LAN communication is disabled, assume that the user changes the setting of battery voltage level to 10. In this case, main CPU 22 issues the command for enabling wireless LAN communication to wireless LAN control unit 2b, upon recognition that the current battery voltage level is higher than 10.

As described above, digital camera 1 enables/disables wireless LAN communication depending on the battery voltage level set by the user. Accordingly, digital camera 1 achieves power source management depending on user's desired usage.

Assuming that “Only When Connected to External Power Source” has been selected, main CPU 22 controls wireless LAN control unit 2b to enable wireless LAN communication only when connected to the external power source. This avoids battery exhaustion by wireless LAN communication.

When the user operates the menu key on the battery voltage level setting screen shown at (d) in FIG. 3, digital camera 1 changes the battery voltage level setting screen back to the screen shown at (a) in FIG. 3on which the image based on the digital image signal is displayed.

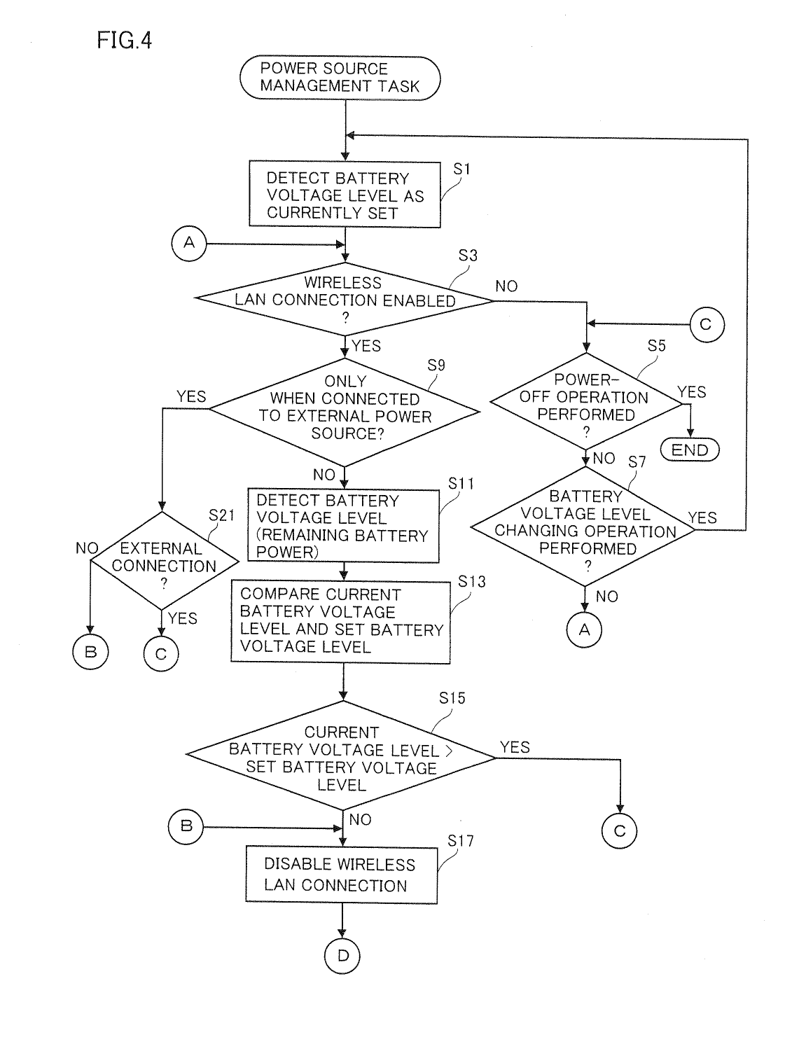

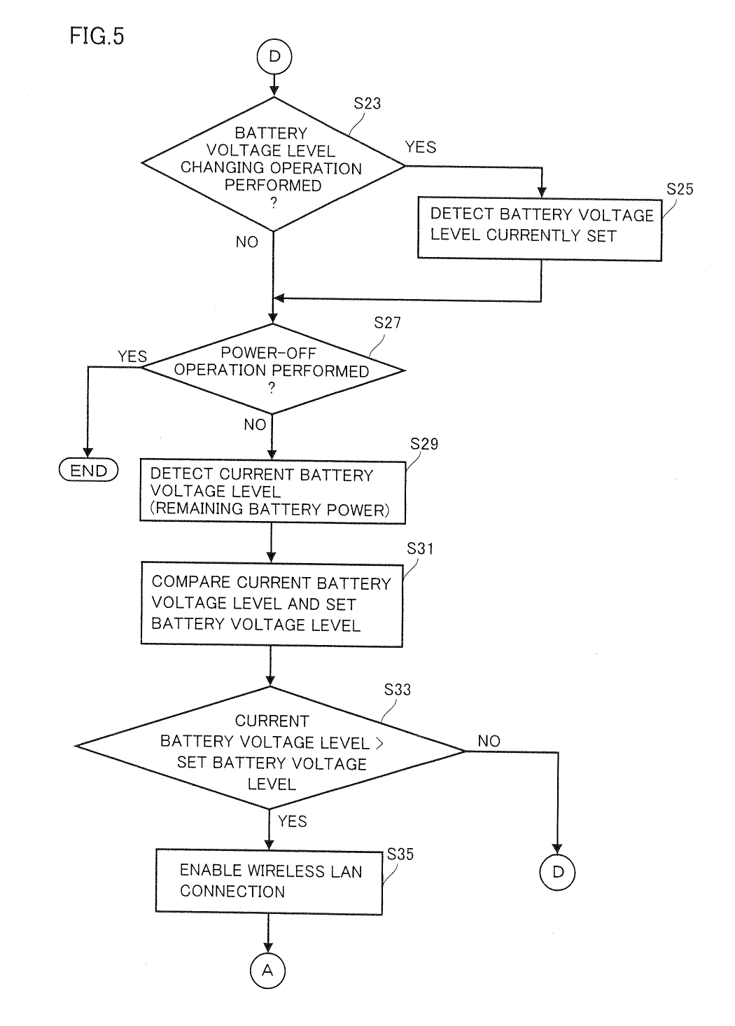

FIG. 4 is a flow chart showing a part of an operation executed by main CPU 22 in digital camera 1. FIG. 5 is a flow chart showing another part of the operation executed by main CPU 22. With reference to FIGS. 4 and 5, the procedure (battery management task) of enabling/disabling wireless LAN communication executed by main CPU 22 depending on the battery voltage level set by the user will now be described.

When sub CPU 34 sends an identification signal to power source control unit 28 and main CPU 22 upon detection that the main switch of operation unit 36 has been operated, main CPU 22 activates the battery management task.

At step S1, main CPU 22 detects the battery voltage level as currently set which is stored in register 22a. The process then proceeds into step S3, at which main CPU 22 determines whether or not wireless LAN communication has been enabled at (c) in FIG. 3. When it is determined NO at step S3, main CPU 22 determines at step S5 whether or not an identification signal for powering off based on the operation of the main switch of operation unit 36 has been received from sub CPU 34. When it is determined YES at step S5, main CPU 22 terminates the battery management task. When it is determined NO at step S5, main CPU 22 causes the process to proceed into step S7.

At step S7, main CPU 22 determines whether or not the battery voltage level has been changed by the operation of the menu key, the cursor key, and the set key as described above. When it is determined YES at step S7, main CPU 22 returns the process to step S1. When it is determined NO at step S7, main CPU 22 returns the process to step S3.

When it is determined YES at step S3, main CPU 22 determines at step S9 whether or not the battery voltage level stored in register 22a is “Only When Connected to External Power Source.” When it is determined NO at step S9, main CPU 22 controls power source control unit 28 at step S11 to detect the current voltage value of battery 42, and then detect the current battery voltage level (remaining battery power) based on that voltage value.

Main CPU 22 then compares at step S13 the current battery voltage level and the set battery voltage level. Main CPU 22 determines at step S15 whether or not the current battery voltage level is greater than the set battery voltage level. When it is determined YES at step S15, main CPU 22 returns the process to step S5. When it is determined NO at step S15, main CPU 22 controls wireless LAN control unit 2b at step S17 to disable wireless LAN data communication. Thereafter, main CPU 22 causes the process to proceed into step S23.

When it is determined YES at step S9, main CPU 22 monitors power source control unit 28 at step S21 to determine whether or not external power source 44 is connected based on the monitoring. When it is determined YES at step S21, main CPU 22 causes the process to proceed into step S5. When it is determined NO at step S21, main CPU 22 causes the process to proceed into step S17.

At step S23, main CPU 22 determines whether or not the battery voltage level has been changed by the operation of the menu key, the cursor key, and the set key. When it is determined YES at step S23, main CPU 22 detects at step S25 the battery voltage level stored in register 22a. Main CPU 22 then causes the process to proceed into step S27. When it is determined NO at step S23, main CPU 22 determines at step S27 whether or not a power-off operation has been performed.

When it is determined YES at step S27, main CPU 22 terminates the battery management task. When it is determined NO at step S27, main CPU 22 detects the current battery voltage level (remaining battery power) at step S29. Main CPU 22 compares at step S31 the current battery voltage level and the set battery voltage level. Main CPU 22 determines at step S33 whether or not the current battery voltage level is greater than the set battery voltage level. When it is determined NO at step S33, main CPU 22 returns the process to step S23. When it is determined YES at step S33, main CPU 22 controls wireless LAN control unit 2b at step S35 to enable wireless LAN data communication. Thereafter, main CPU 22 returns the process to step S23.

In the present embodiment, compressed image data is stored in memory card 2. More specifically, the compressed image data is stored in a file format. Compressed image data of a still picture is stored in a JPEG file format. Compressed data of a motion picture is stored in an MPEG file format or a motion JPEG file format. Therefore, the compressed image data is transmitted per file from digital camera 1 to PC 8 by wireless LAN communication.

Digital camera 1 according to the present embodiment disables wireless LAN communication when the battery voltage level falls below the set level. However, when the battery voltage level falls below the set level while compressed image data of a motion picture having a large amount of data is transmitted to PC 8, digital camera 1 disables wireless LAN communication after the transmission of the compressed image data being transmitted to PC 8 per file is completed.

Digital camera 1 according to the present embodiment transmits the compressed image data stored in memory unit 2a to PC 8 while wireless LAN communication is enabled. Digital camera 1 may be configured to allow the user to select the compressed image data to be transmitted. Digital camera 1 may also be configured such that the compressed image data stored in memory card 2 in digital camera 1 having been transmitted is deleted after the transmission to PC 8. In this case, the data storage capacity of wireless LAN built-in memory card 2 can be efficiently utilized.

It is to be noted that, with a conventional digital camera, an external memory card deals with problems caused when the digital camera is powered off while a motion picture file is transferred. More specifically, in the case where communication between the external memory card and a receiving apparatus is interrupted by powering off the digital camera, the receiving apparatus stores information indicative of an interrupted location. Thereafter, when the digital camera is powered on to enable communication between the external memory card and the receiving apparatus, the external memory card restarts data transmission at the interrupted location based on the information stored in the receiving apparatus. Accordingly, the digital camera can be powered off immediately upon receipt of a power-off command from the user.

As described above, according to the present embodiment, digital camera 1 can also exert communication control depending on user's desired usage when digital camera 1 conducts wireless communication by power supplied from battery 42 inserted into the body of digital camera 1. Moreover, according to the present embodiment, digital camera 1 loaded with memory card 2 ensures a user's desired battery voltage level when conducting wireless LAN communication.

While the above description has addressed digital camera 1 as an example of the wireless communication apparatus, the wireless communication apparatus is not limited to the digital camera. The wireless communication apparatus may be specialized, for example, in an image reproducing function, such as a digital photo frame, obtained by excluding the image capture function from digital camera 1 according to the present embodiment. Alternatively, the wireless communication apparatus may be specialized, for example, in an audio recording/reproducing function, such as an IC (Integrated Circuit) recorder. In that case, the wireless communication apparatus is provided with a sound pickup function instead of the image capture function in digital camera 1 and a sound reproducing function instead of the image reproducing function. It is to be noted that the sound pickup function represents capturing sound and generating an audio signal based on the captured sound. More specifically, the sound pickup function represents a function of converting a sound wave into an electric signal. The sound pickup function is implemented by a sound pickup device (e.g., microphone) provided for the digital camera.

Although being stored in memory card 2, the wireless LAN function may be built into digital camera 1 serving as the wireless communication apparatus. Alternatively, the wireless LAN function may be separated from memory card 2, and a wireless LAN adapter such as a wireless LAN card may be connected to the digital camera.

Further, an AC adapter may be used as external power source 44.

The above description has been directed to, by way of example, the configuration in which the current battery voltage level and the set battery voltage level are compared (step S13 in FIG. 4 and step S31 in FIG. 5), however, this is not a limitation. Digital camera 1 may be configured such that the detected battery voltage level (step S11 in FIG. 4 and step S29 in FIG. 5) and the set battery voltage level are compared.

While the example shown at (d) in FIG. 3 illustrates four battery voltage levels, digital camera 1 may be configured to allow the user to freely select the battery voltage level in the power source management from values between 0 and 100.

### <Notes>

A wireless communication apparatus which conducts wireless communication with an external apparatus includes a memory which stores audio data, an establishment unit which establishes wireless communication between the external apparatus and the body of the wireless communication apparatus, a communication unit which transmits the audio data to the external apparatus by the wireless communication as established, a reproduction unit which reproduces the audio data, a battery which supplies power to the communication unit and the reproduction unit, a determination unit which detects remaining battery power of the battery to determine whether or not the detected remaining battery power falls below a predetermined value, and a control unit which disconnects the wireless communication established by the establishment unit based on a determination that the remaining battery power falls below the predetermined value, to interrupt transmission of the audio data conducted by the communication unit.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A wireless communication apparatus which conducts wireless communication with an external apparatus, comprising:
an image capture unit which captures an image of a subject;
a memory which stores image data based on said captured image;
an establishment unit which establishes wireless communication between said external apparatus and a body of said wireless communication apparatus;
a communication unit which transmits said image data to said external apparatus by said wireless communication as established;
a battery which supplies power to said image capture unit and said communication unit;
a determination unit which detects remaining battery power of said battery to determine whether or not the detected remaining battery power falls below a predetermined value; and
a control unit which disconnects the wireless communication established by said establishment unit, based on a determination that said remaining battery power falls below said predetermined value, to interrupt transmission of said image data conducted by said communication unit.

2. The wireless communication apparatus according to claim 1, further comprising:
a receiving unit which receives an input; and
a changing unit which changes said predetermined value based on said input as received.

3. The wireless communication apparatus according to claim 2, wherein said receiving unit is a user interface which receives a user's operation.

4. The wireless communication apparatus according to claim 1, wherein said determination unit includes
a level detecting unit which detects an output voltage level of said battery, and
a level determining unit which determines whether or not said output voltage level falls below a predetermined level, and
said determination unit determines that said remaining battery power of said battery falls below said predetermined value when said level determining unit determines that said output voltage level falls below said predetermined level.

5. The wireless communication apparatus according to claim 4, further comprising:
a receiving unit which receives an input; and
a changing unit which changes said predetermined level based on said input as received.

6. The wireless communication apparatus according to claim 5, wherein said receiving unit is a user interface which receives a user's operation.

7. The wireless communication apparatus according to claim 1, wherein said control unit causes said establishment unit to establish said wireless communication when said power is supplied from an external power source instead of said battery while said transmission is interrupted by said control unit.

8. A wireless communication apparatus which conducts wireless communication with an external apparatus, comprising:
a memory which stores image data;
an establishment unit which establishes wireless communication between said external apparatus and a body of said wireless communication apparatus;
a communication unit which transmits said image data to said external apparatus by said wireless communication as established;
a display unit which displays said image data;
a battery which supplies power to said communication unit and said display unit;
a determination unit which detects remaining battery power of said battery to determine whether or not the detected remaining battery power falls below a predetermined value; and
a control unit which disconnects the wireless communication established by said establishment unit, based on a determination that said remaining battery power falls below said predetermined value, to interrupt transmission of said image data conducted by said communication unit.

9. The wireless communication apparatus according to claim 8, further comprising:
a receiving unit which receives an input; and
a changing unit which changes said predetermined value based on said input as received.

10. The wireless communication apparatus according to claim 9, wherein said receiving unit is a user interface which receives a user's operation.

11. The wireless communication apparatus according to claim 8, wherein said determination unit includes
a level detecting unit which detects an output voltage level of said battery, and
a level determining unit which determines whether or not said output voltage level falls below a predetermined level, and
said determination unit determines that the remaining battery power of said battery falls below said predetermined value when said level determining unit determines that said output voltage level falls below said predetermined level.

12. The wireless communication apparatus according to claim 11, further comprising:
a receiving unit which receives an input; and
a changing unit which changes said predetermined level based on said input as received.

13. The wireless communication apparatus according to claim 12, wherein said receiving unit is a user interface which receives a user's operation.

14. The wireless communication apparatus according to claim 8, wherein said control unit causes said establishment unit to establish said wireless communication when said power is supplied from an external power source instead of said battery while said transmission is interrupted by said control unit.

15. A wireless communication apparatus which conducts wireless communication with an external apparatus, comprising:
a sound pickup device which converts a sound wave into an electric signal;
a memory which stores audio data based on said electric signal;
an establishment unit which establishes wireless communication between said external apparatus and a body of said wireless communication apparatus;
a communication unit which transmits said audio data to said external apparatus by said wireless communication as established;
a battery which supplies power to said sound pickup device and said communication unit;
a determination unit which detects remaining battery power of said battery to determine whether or not the detected remaining battery power falls below a predetermined value; and
a control unit which disconnects the wireless communication established by said establishment unit, based on a determination that said remaining battery power falls below said predetermined value, to interrupt transmission of said audio data conducted by said communication unit.

16. The wireless communication apparatus according to claim 15, further comprising:
a receiving unit which receives an input; and
a changing unit which changes said predetermined value based on said input as received.

17. The wireless communication apparatus according to claim 16, wherein said receiving unit is a user interface which receives a user's operation.

18. The wireless communication apparatus according to claim 15, wherein said determination unit includes
a level detecting unit which detects an output voltage level of said battery, and
a level determining unit which determines whether or not said output voltage level falls below a predetermined level, and
said determination unit determines that the remaining battery power of said battery falls below said predetermined value when said level determining unit determines that said output voltage level falls below said predetermined level.

19. The wireless communication apparatus according to claim 18, further comprising:
a receiving unit which receives an input; and
a changing unit which changes said predetermined level based on said input as received.

20. The wireless communication apparatus according to claim 15, wherein said control unit causes said establishment unit to establish said wireless communication when said power is supplied from an external power source instead of said battery while said transmission is interrupted by said control unit.
